(19) United States
(12) Patent Application Publication
(10) Pub. No.: US 2006/0254551 A1
(43) Pub. Date: Nov. 16, 2006

(54) Recessed passage combustion engine intake structure and working process

(76) Inventor: Martin Fields, Louisville, KY (US)

Correspondence Address: Martin Fields, 2718 Seminary Court, Louisville, KY, 40206-2857, US

(21) Appl. No.: 11/335,451

(22) Filed: Jan. 19, 2006

Related U.S. Application Data
(60) Provisional application No. 60/644,775, filed on Jan. 19, 2005.

(51) Int. Cl. F02M 35/10

(52) U.S. Cl. 123/184.46

(57) ABSTRACT

An internal combustion engine recessed manifold entry reducing internal/external merge intake collector structure and working process for two and four-barrel carburetor and fuel-injection throttle-body throttles and manifolds. Normally located between the carburetor/throttle-body and the engine intake manifold, this device's design has recessed internal/external merged-bore passages that extend into the intake manifold entry area. Lowering the flow passages into the manifold plenum provides the opportunity to have their passages channel reverse runner flow away from the entry air throttles. This is accomplished by externally merging the multiple throttles' flow passages together so that they can be lowered to extend below the manifold mating flange surface. These changes allow more flow efficient performance tuning that deliver higher specific output power while making more efficient use of the air and fuel being consumed by the engine. They result in greater torque, horsepower, acceleration response, and smoother more reliable and consistent performance with less wear. These are done to make the engine's cylinders more stable and efficient.

### CROSS-REFERENCE TO RELATED APPLICATIONS

This application claims the benefit of provisional application Ser. No. 60/644,775, filed 2005 Feb. 19 by the inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to internal combustion engine carburetor/fuel-injection throttle-body intake flow collectors, specifically to such collectors which are used for collecting the flow of carburetor and fuel-injection throttle-body throttles and intake manifold entries with maximum flow control efficiency.

2. Prior Art

One of the ways that performance engines have been modified to produce increased power has been trough improvements that increase the amount of air an engine can flow in and out of its combustion chambers over a given amount of time. Sometimes this is achieved by the additional pumping of air made possible by increases in engine crankshaft speed. Other times it is done through increases in the amount of air the intake and exhaust breathing systems can exchange with the atmosphere per crankshaft revolution.

The utilization of carburetor/fuel-injection throttle-body spacers have been around since the 1920's when transportation piston engine design began to include carburetor spacers that were used to help insulate the carburetor from the degrading effects of engine heat on the air/fuel mixture and its deterioration of engine efficiency. Eventually carburetor spacers began to be produced for better engine output performance than the earlier designs provided. This was done by the manufacturing factory engineers to enable them to claim that their vehicle's engines produced more horsepower than their competitor's. Speed quickly became a popular marketing tool.

Before long, innovators of aftermarket performance engine components who were trying to make improvements in power output for use in competition events, began to improve the breathing characteristics of these original equipment engines. On the intake side of the engine, intake manifolds are typically employed to distribute and deliver air/fuel mixtures from the carburetor throttle-valve assembly to the engine cylinder head(s). Carburetor spacers were found to make significant improvements in engine power because they were able to increase the amount or quality of mixture flow into the intake manifold on its way to entering the engine cylinders.

Conventional performance engines commonly employ the use of carburetor/fuel-injection throttle-body spacers that raise the throttle assembly in relation to the intake manifold throttle mounting flange to give the incoming flow more room to make the turns from the throttles into their respective manifold runners. Conventional throttle mounting is often spaced away from the intake manifold using various spacer designs that have one large passage that all of the multiple throttle flow goes through, individual passages dedicated to individual throttles for some specific passage length, outward tapered passages dedicated to individual throttles, or some combination of the above.

Single large opening throttle spacers are the greatest detriment to controlling inward intake flow since the throttle to manifold runner entry cross-sectional area transition has the greatest size change of any throttle to runner entry configurations. When the incoming charge air/mixture encounters the sudden change in cross-sectional area, being approximately fourteen times lighter than the fuel, in the case of gasoline, it instantly slows down by the factor of the cross-sectional area change it is passing through. The fuel component of the mixture generally continues at the same flow speed establishing instant separation from it's carrier air in varying degrees. Although some configurations of “open-hole” spacers have reverse flow control shears that extend below the spacer lower mounting flange, doing so in the absence of turbulence-free inward flow produces little return on its incorporation into the intake flow-stream. Individual passage “4-hole” spacers dedicated to individual throttles for a specific passage length have desirable effects on tuning the rate of flow going through their passages for some specific desired effect on air-flow performance, however by their lack of the resolution of intake turbulence they provide no change from that of the carburetor/fuel-injection throttle-body throttles themselves, being merely extensions of them. Interior expanding-taper passage “tapered 4-hole” spacers, such as those manufactured by High Velocity Heads, CV Products, Wilson Manifolds, Jomar, and others, some of which were produced beginning in the 1980's, are internal merge intake expansions that help increase flow stability gradually blending the throttle cross-sectional areas into the manifold opening, however they provide little opportunity to reduce the manifold opening to the minimum cross-sectional area of only the manifold runners participating in overlapping cylinders' inward flow active at any one time. A combination of these expanding internal merge tapered 4-hole spacers includes a recessed passage reversion shear configuration, manufactured by Schmidt Motor Works and others, that has little benefit since the internal merge expansion inverted funnel's effect itself significantly negates the opportunity for a reverse flow feature to bypass outward directed flow away from traveling up through the throttles into the atomization end of the carburetor or back out into the atmosphere where it originally came from on carbureted and fuel-injected engines. However, all of these designs continue to exhibit major flow losses that have previously hindered this area of throttle and intake manifold component matching and breathing/combustion efficiency.

Although all the above spacer configurations usually offer some improvements to engine airflow, they each have drawbacks that restrict the extraction of optimum performance from engines utilizing carburetor/fuel-injection throttle-body entry-air control valves. Each of these methods fails to maintain efficient levels of air or mixture flow passage size change from the throttles to the intake manifold runner passage entries. My provisional patent application Ser. No. 60/644,775, provides for a carburetor/fuel-injection throttle-body merge intake collector that makes the transition from the throttle outlets to the intake manifold runner entries without sudden or inefficient changes in passage cross-sectional area by the incorporation of a recessed manifold entry reducing internal/external merge intake collector that maintains the smooth, uniform, and relatively turbulence-free flow of air or air/fuel mixture through the individual passages enabling it to include the recessed passage reversion shear feature for the optimum control of intake charge flow.

### OBJECTS AND ADVANTAGES

Several objects and advantages of the present invention are:

(a) to provide a structure and working process that improves incoming engine air/mixture flow control to the point that reverse flow is not removing flow energy from the traveling media as it passes through the engine throttle to manifold runner entry transition section of the intake breathing flow-stream;

(b) to provide a structure and working process that provides the means for the traveling fuel energy to not experience flow-path induced pressure fluctuations that fail to retain the full level of a carburetor's air/fuel mixture atomization necessary for the subsequent mixture vaporization that is essential in order for a combustion engine to extract all the potential energy that it carries into an engine's cylinders;

(c) to provide a structure and working process that provides the means for the traveling air energy to not experience flow-path induced pressure fluctuation and pumping losses that disturb the distribution of fuel-injection throttle-body and intake manifold charge air entry into it's runners prior to delivery into the engine cylinders necessary for an engine breathing system to reach full volumetric efficiency and the subsequent maximum extraction of work from a given cylinder displacement and ingested fuel energy content, stable/efficient fuel-injector pressure differentials, or produce unstable electronic fuel-injection sensor signal readings;

(d) to provide a structure that presents a working process that enables increased air/mixture intake throttle and manifold flow density to enter the engine cylinders on a consistent per cycle basis thereby increasing engine power production;

(e) to provide a structure and working process that enables the smoothing of intake charge air and fuel flow curves that provide smooth power characteristics that travel through the downstream power transmission to the contact point of the power drive and the media through which it establishes working motion;

(f) to provide a structure and working process that produces a substantially vertical solid column of intake charge air/mixture that has concentrates peak outwardly directed pressure that enhances the pressure differential of cylinder charging from the atmosphere to the engine's working cylinders;

(g) to provide a structure and working process that provides greater control and productive combination of more volumetrically efficient components such as larger than commonly used entry-charge throttles to be incorporated with the use of with smaller than commonly used charge distribution manifold runner volumes;

(h) to provide a structure and working process that allows the management of carburetor, or fuel-injection sensors and injectors, establishment of narrow local air/fuel mixture ratios in the cylinder to be retained the length of the intake passage flow-stream and into the engine cylinders thereby allowing full fueling and ignition operation efficiencies to be realized;

(i) to provide a structure and working process that allows the establishment and productive application of leaner more power-productive average air/fuel mixture ratios than previously employed to be successfully utilized absent of the normal structural weaknesses incurred with conventional methods of engine operation;

(j) to provide a structure and working process that allows the establishment and productive application of more power-productive faster burning intake charges to efficiently operate with reduced ignition timing requirements for optimum engine power.

### SUMMARY

In accordance with the present invention a merge intake collector that is externally reduced, without restricting inward air/air-fuel mixture flow, for the maximum resistance to outward air/air-fuel mixture flow located between the entry air/air-fuel mixture throttles and intake charge delivery/distribution manifold.

### DRAWINGS—FIGURES

FIG. 1 shows a upper perspective view of the recessed intake passage invention preferred embodiment.

FIG. 2 shows a top view of the recessed intake passage invention preferred embodiment.

FIG. 3 shows a side elevation view of the recessed intake passage invention preferred embodiment.

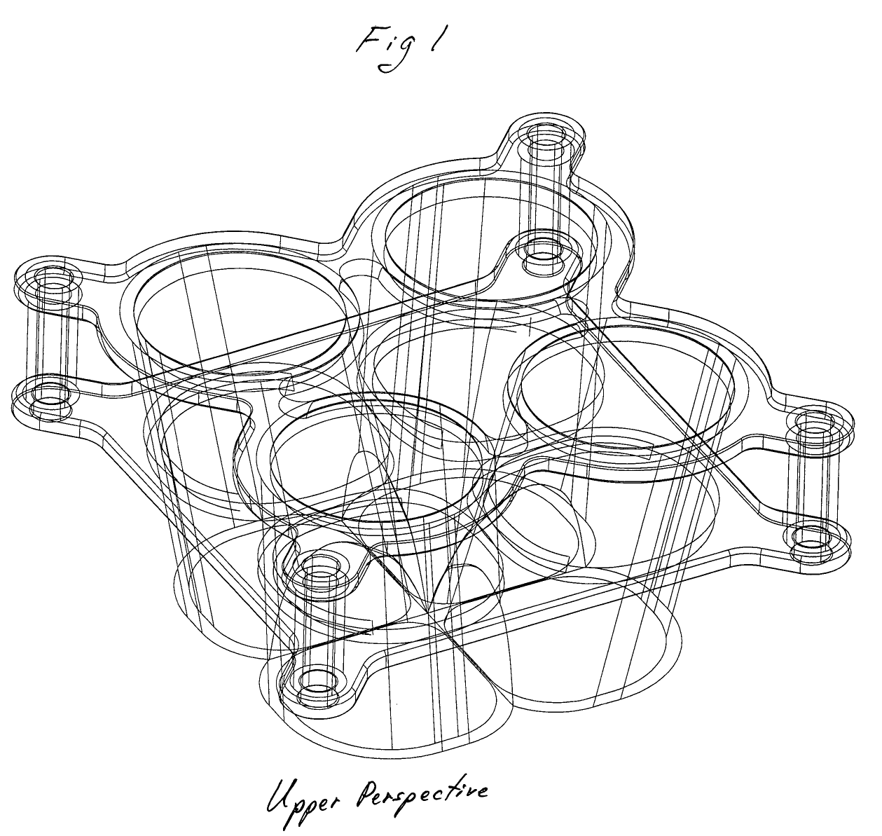

### DETAILED DESCRIPTION—FIGS. 1-3 AND PREFERRED EMBODIMENT

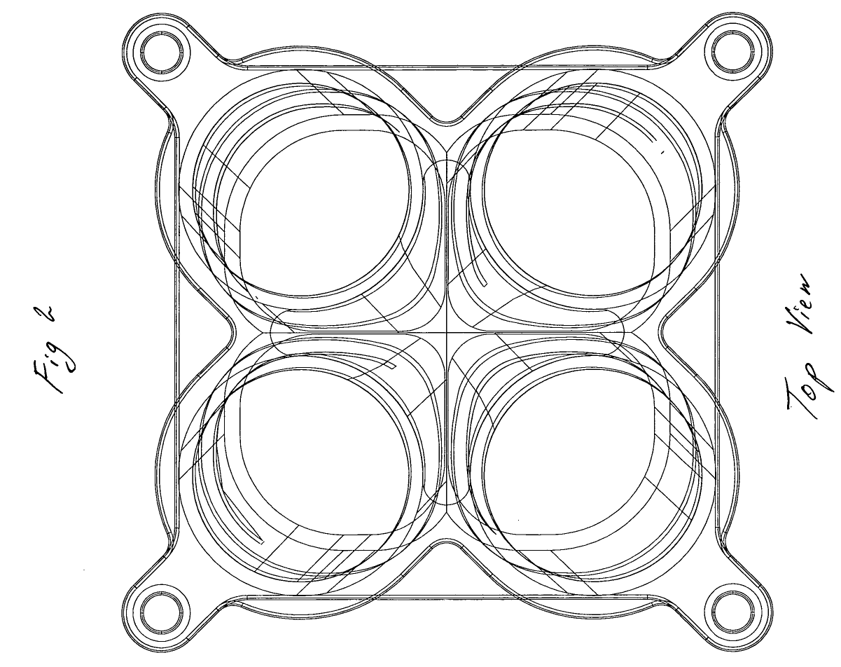

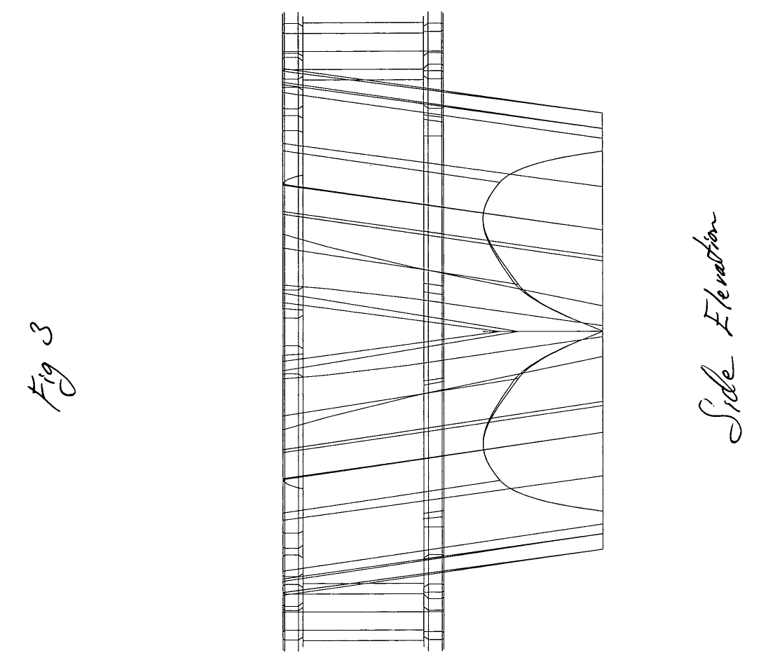

A preferred embodiment of the recessing of the internal/external merge intake collector invention is illustrated in FIG. 1 (upper perspective view), FIG. 2 (top view), and FIG. 3 (side elevation view). The recessing of the internal/external merging of the passages is described by the protrusion of the internal/external merge passages beyond the lower mounting flange surface. In the preferred embodiment, the entire surface is computer-machined from 6061-T6 billet aluminum for minimum weight with maximum strength and a smooth surface finish. However, the entire part may be successfully constructed of any material that can be machined, cast, molded, formed from automated processes, etc. that meet the desired application's requirements for accuracy, dimensional stability, structural integrity, and working conditions such as chemical attack and operating temperature.

At the upper end of the part the flow passage entries are round to match the round carburetor/fuel-injection throttle-body throttles. At the lower end of the flow passage outlets are rounded square/rectangles to minimize the external space needed to contain the combined flow passage cross-sectional areas. Between the upper and lower passage ends the mounting flanges are supported by through-bolt fastener sleeves. Additional configurations of mounting include thicker flanges that are heavy enough to support the part and the weight and mechanical forces they are subjected to during operation without the use of bolt sleeves and only drilled or threaded bolt holes. Alternative mounting arrangements from conventional gasket/o-ring sealing and securing fastener configurations or flow-stream placement other than adjacent to the throttle assembly's mounting flange or intake manifold throttle assembly mounting flange can be utilized within the scope of the present invention.

The dimensions of the preferred embodiment are 6.125″L×6.125″W×3.00″H. In the preferred embodiment, the passage entries are 2.00″ i.d. However, various passage entry diameters are employed. Passage outlets are determined by the size of the passage entries for each particular model and specific application usage.

Operation—FIGS. 1, 2, 3

The manner of using the recessed manifold reducing merge invention is a working process combination wherein it's structure is installed in the conventional carburetor spacer location between the carburetor or fuel-injection throttle-body and the intake distribution manifold, but that enables significantly improved power producing methods to tailor it to the carburetor's or fuel-injection throttle-body's and intake manifold's enhanced levels of air/mixture flow quantities and quality. Although new fuel metering and ignition spark-timing settings are essential to the productiveness of the structure's working process combination with the air/mixture passage media and the engine breathing order air exchange events with the atmosphere, the method and position of attachment between the carburetor or fuel-injection throttle-body and the intake distribution manifold remains unchanged, although the scope of the invention does not preclude alternative flow-stream mounting positions or attachment fastener configuration.

### CONCLUSION, RAMIFICATIONS, AND SCOPE

The improvements that this invention provide assist performance and racing engines in their transferring power producing air/air-fuel mixtures from outside the engine cylinders into them as efficiently as possible.

The potential for this invention to improve engine performance is not only in the areas of power production but also to reduced engine operation wear and safety as specific power levels continue to increase.

The scope of the present invention provides for the placement of the multi-passage merge intake collector between the carburetor/fuel-injection throttle-body throttles and the intake manifold mounting flanges, however it is not limited to placement location in the air flow-stream or to method of incorporation into the flow-stream whether it be integrated or bolt-on design. The scope of the invention is not limited by the number of throttle passages or intake manifold distribution runners.

It is understood that the invention has been described in the preferred embodiment, however various other embodiments and variations are possible within the scope and spirit of the invention, and such embodiments and variations are intended to be covered by the following claims.

It is claimed:

1. A intake collector for a multi-cylinder internal combustion engine, wherein the internal combustion engine includes a carburetor/fuel-injection throttle-body and an intake distribution runner manifold, the intake collector comprising:
a plurality of air/air-fuel mixture passages;
wherein said plurality of air/air-fuel mixture passages have entries,
wherein said plurality of air/air-fuel-mixture passages have outlets,
wherein said air/air-fuel mixture passage entries are adjacently grouped,
wherein said air/air-fuel mixture passage outlets are adjacently grouped,
wherein said plurality of adjacent air/air-fuel mixture passage entries and outlets are externally merged,
wherein said plurality of adjacent air/air-fuel mixture passage entries and outlets are internally merged,
wherein said plurality of merged passages have an upper mounting flange,
wherein said plurality of merged passages have an lower mounting flange,
wherein said plurality of merged passages recess beyond the mounting flanges into a manifold opening,
wherein said manifold opening is interfaced with said recessed merge passages.

2. In combination:
an internal combustion engine
wherein said internal combustion engine includes working cylinders,
wherein said working cylinders contain reciprocating pistons,
wherein said reciprocating pistons are adjacent to cylinder-heads,
wherein said cylinder-heads are connected to an air distribution manifold,
wherein said air distribution manifold is connected to a carburetor/fuel-injection throttle-body an air throttle assembly,
